(19) United States
(12) Patent Application Publication
(10) Pub. No.: US 2010/0277422 A1
(43) Pub. Date: Nov. 4, 2010

(54) TOUCHPAD DISPLAY

(75) Inventors: Tobias Muresianu, Seattle, WA (US); Zachary Shaklcross, Bothell, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/433,814

(22) Filed: Apr. 30, 2009

(51) Int. Cl. G06F 3/041

(52) U.S. Cl. 345/173

(57) ABSTRACT

A computing system is provided, including a primary display and a touchpad having an operative surface that is distinct from a display surface of the primary display. The computing system further includes an interface subsystem having a touchpad input module and a touchpad output module. The touchpad input module is responsive to touch inputs applied to the operative surface to provide cursor control over data represented on the primary display. The touchpad output module may be driven to provide visual effects output based on cursor control inputs received on the touchpad and/or primary display output in which at least a portion of the touchpad provides an additional primary display of the computing system.

### BACKGROUND

Computing systems have become increasingly sophisticated in providing users with a rich interactive experience. One area where interactivity has improved is the provision of input functionality on displays and other devices that traditionally were used primarily or solely for output. Because display screens typically display data that the user wants to manipulate or control, technological improvements eventually led to being able to achieve this control through input mechanisms more directly linked to the display. For example, touch sensitive display screens are now widely available.

Significantly less work has been done in providing output capability in connection with devices more traditionally used for user input. A potential reason for this is that it is perhaps more natural to bring input functionality to where output occurs, for example by bringing input operations performed by the user's hands closer to where the data is visually represented (i.e., the display). Whatever the reason, many input devices remain limited in their functionality, and opportunities to use these devices to increase user interactivity remain largely unexplored.

### SUMMARY

Accordingly, the present disclosure provides a computing system having a touchpad and a primary display. An interface subsystem is operatively coupled with the touchpad, and includes a touchpad input module responsive to touch inputs applied to an operative surface of the touchpad to provide cursor control over data represented on the primary display. The interface subsystem also includes a touchpad output module configured to drive the touchpad to produce visual output. In some embodiments, the touchpad output module drives the touchpad to produce visual effects output on the operative surface of the touchpad in response to the touch inputs applied to the touchpad to provide cursor control. In some embodiments, the touchpad output module drives the touchpad in a primary display mode, in which at least a portion of the touchpad functions to provide an additional primary display for the computing system. Various mode-switching techniques are also provided to control and switch operation among the input mode of the touchpad, and the visual effects and primary display output modes.

The above Summary is provided to introduce a selection of concepts in a simplified form that are further described below in the Detailed Description. This Summary is not intended to identify key features or essential features of the claimed subject matter, nor is it intended to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a schematic depiction of an exemplary computing system according to the present description, including a touchpad and supporting components to provide input and output functionality in connection with the touchpad.

FIGS. 2 and 3 depict exemplary computing devices having touchpads that may be configured in accordance with the present description.

FIGS. 4-6 depict examples of touchpads with exemplary visual effects produced in response to touch inputs applied to the touchpads.

FIG. 7 depicts exemplary state transitions between different operating modes that may be employed in connection with the example touchpad embodiments described herein.

### DETAILED DESCRIPTION

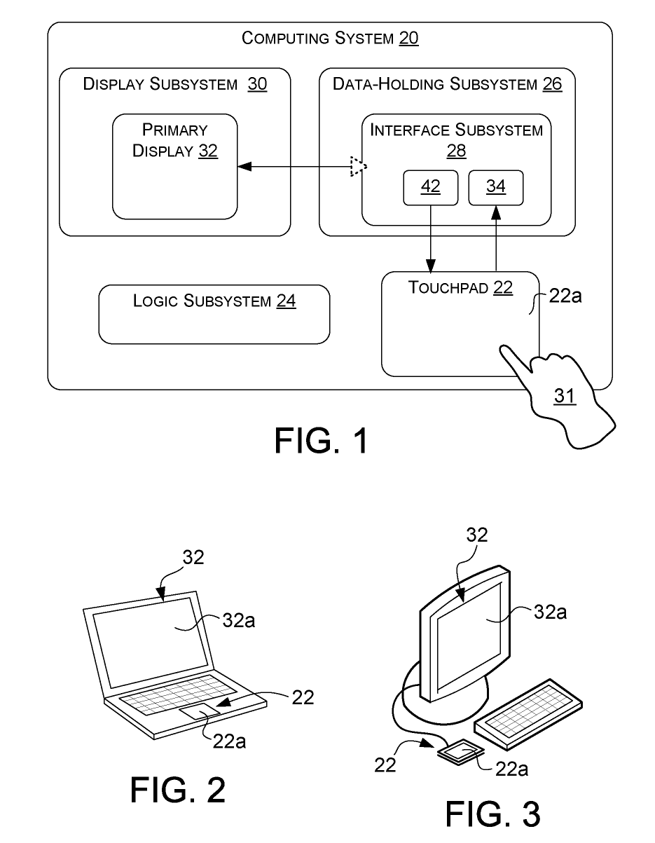

FIG. 1 depicts an exemplary computing system 20 according to the present description, including a touchpad 22 and supporting components/features that provide an improved and enhanced touchpad interface. As indicated, computing system 20 includes a logic subsystem 24 (e.g., a processor) and a data-holding subsystem 26. Data-holding subsystem 26 may include various types of RAM and other memory mechanisms, as well as hard disks and other storage devices.

Logic subsystem 24 is operatively coupled with data-holding subsystem 26 and executes instructions maintained in the data-holding subsystem, including instructions associated with the operating system of computing system 20, and instructions to carry out various processes, routines, applications, etc. More particularly, data-holding subsystem 26 typically contains instructions comprising an interface subsystem 28 which interacts with display subsystem 30 and touchpad 22 to provide input/output functionality. The input functionality provided by touchpad 22 typically is cursor control based on touch inputs provided from a user's hand 31, either directly as shown or via manipulation of a stylus or other implement.

Display subsystem 30 includes a primary display 32 which provides, for applications running on the computing system, visual representations of the applications themselves and the data upon which they are acting. For example, the primary display might display an editing interface for a word processor, along with pages from a particular document being modified by the word processor. In another example, a web browser interface and navigation controls would be displayed along with a framed web page that is being viewed by the user.

Regardless of the particular output being displayed, interface subsystem 28 operates to drive the output to primary display 32, for example via a video card in a desktop computer. In addition, as indicated by the dashed arrowhead pointing from primary display 32 to interface subsystem 28, primary display 32 may also be used to provide input functionality. In particular, in some embodiments, primary display 32 may include a touch-sensitive display screen.

Touchpad 22 provides a mechanism for receiving user input into computing system 20. Other input devices (not shown) which may be employed include keyboards, non-touchpad pointing devices (mouse, trackball, etc.), game controllers, microphones, etc. Referring to touchpad 22, the touchpad is separate from primary display 32 and provides an input instrumentality that is physically distinct from any input capability that may be employed in connection with the primary display.

For example, FIGS. 2 and 3 both show exemplary computing systems which include a primary display 32 and a touchpad 22. Touchpad 22 includes an operative surface 22a which is distinct from a display screen surface 32a of the primary display. To provide input capability, touchpad input module 34 (FIG. 1) is responsive to touch inputs applied to the operative surface of the touchpad so as to provide cursor control over data represented on the primary display. The touch inputs may include static and/or dynamic touches from a user's fingers, such as tapping, movement of the user's finger across the surface, etc. Additionally, or alternatively, other implements may be employed to apply the touch inputs, such as a stylus.

In some cases, the user experience may be enhanced by using the touchpad to provide visual output to the user on the operative surface 22a of the touchpad. Such output functionality may be controlled or driven by an output touchpad module 42 of interface subsystem 28. In one class of examples, touchpad output module 42 operates in a visual effects output mode. In this mode, the output module drives the touchpad to display visual effects on the operative surface of the touchpad based on the cursor control touch inputs that are applied to the touchpad.

When operating in the visual effects output mode, the output produce by the touchpad output module 42 typically is a contemporaneous visualization of the actual touch inputs applied to the operative surface of the touchpad. For example, one visual effect is a finger painting effect, in which movement of the user's finger across the touchpad leaves a persisting trail on the surface of the touchpad. Such an effect could be implemented in various ways, including adjustable coloration of the persisted trail; time-based fading of the trail; effects to simulate bleeding (e.g., ink or paint bleeding into paper), smearing, smudging, etc. This trail-type effect may also be employed in connection with a stylus, in which the visible trail would be created in response to the dynamic contact of the stylus point with the touchpad surface. Indeed, though many of examples herein are discussed in the context of a finger touch input, it will be readily appreciated that the discussion is equally applicable to stylus and other touch inputs.

Persistence may also be employed with static touches, such as finger touches that are not dragged or drawn in a dynamic way across the touchpad surface. In such a case, marks (e.g., fingerprint-type marks) would be left by the prior touch inputs and retained, either indefinitely or for some finite period of time.

Another example effect would be to alter the appearance of the touchpad during application of the touch input. For example, the touchpad could flash a particular color for the duration of a touch input, or the entire touchpad surface could be held at a particular color, pattern or image for the duration of the touch input.

Still another example is to provide visual output in a region of the touchpad immediately adjacent and/or surrounding the point of contact with the touchpad. For example, a halo or aura-type image could surround a user's fingertip, or a bulls-eye, target, crosshairs, etc.

A further contact-based example would be to simulate a mechanical deflection of the operative surface of the touchpad. For example, upon contact of a user's fingertip or the point of a stylus with a location on the touchpad, the imagery output on the touchpad would be adjusted to visually simulate that the contact was pressing into the touchpad and causing a localized depression on the touchpad. In one example, the simulated depression would be elastic, such that the touchpad surface would appear to spring back to its pre-deflected state upon withdrawal or movement of the user's finger away from the point of contact. Alternatively, the deflection effect could be persisted, for example causing a furrow or series of depressions to remain as a result of prior touch inputs.

In addition, various background imagery may be employed in connection with the visual effects described above. For example, a user-selected photograph may be provided as a backdrop (e.g., wallpaper) for the touchpad. In such a use, the photograph would be output to the touchpad by touchpad output module 42. With such a backdrop, the finger painting effect described above would result in the visible trail being applied over the top of the backdrop photo in some pre-defined color. Instead of a particular color, a smearing or smudging effect could be applied to the photo, or a re-touch or airbrush effect, based on the touch inputs.

The contact and deflection effects described above can also be employed with a wallpaper or other backdrop on the touchpad. For example, the halo, aura, crosshairs, etc. can be laid over the backdrop photo in response to an applied touch input. For the deflection effects, the effect could simulate a photo or painting on a deflectable material (e.g., a canvas) stretched over a rigid perimeter frame. Then, touching the touchpad would simulate pressing and deflecting of the deflectable material.

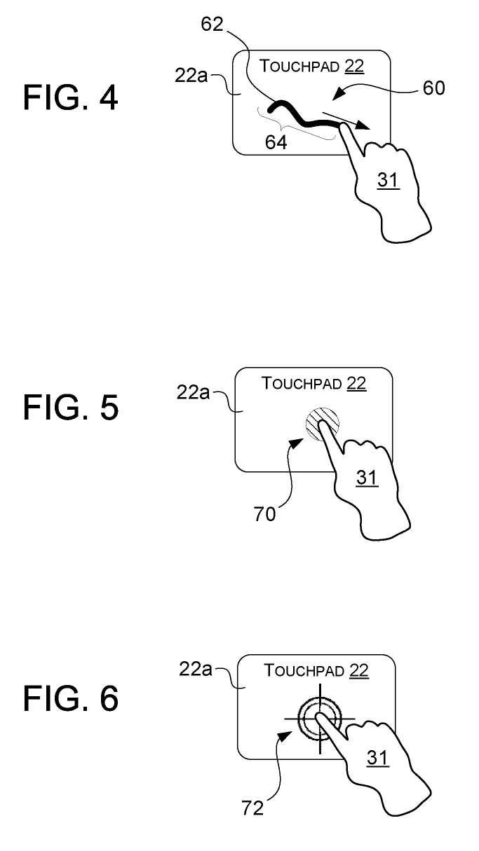

From the above, it will be appreciated that one class of visual effects may be considered “persistence effects.” With these visual effects, marks on the touchpad are generated in response to particular touch inputs (e.g., from a fingertip or stylus), and those marks remain, at least temporarily, as visual effects on the touchpad after the touch input changes, i.e., is moved or withdrawn. For example, FIG. 4 shows an exemplary visual persistence effect 60 produced on operative surface 22a of touchpad 22. In this example, the effect is a visible trail 62 located in a wake region 64 of a dynamic touch input applied from a user's hand 31. As described above, various parameters of the effect may be adjusted to provide wide variation in the static and dynamic appearance of the trail. With respect to persistence, the trail may be persisted indefinitely or it may be transitory and caused to fade from the touchpad over time.

FIGS. 5 and 6 provide examples of touch-surround or contact-based visual effects. These effects typically do not depend on a dynamic input, and produce a visible effect even where the touch input is static (e.g., a finger rested in a particular location on the touchpad). FIG. 5, for example shows an aura effect 70 produced on a region of the touchpad which surrounds and is proximally adjacent the point of contact with the user's fingertip. FIG. 6 shows a crosshair effect 72 surrounding the contact point of the touch input.

In addition to the input and visual effect capabilities described above, it may in some cases be desirable to employ the touchpad as a supplement to primary display 32. In particular, touchpad output module 42 may be configured to drive the touchpad in a primary display mode, in which at least a portion of the touchpad provides an additional primary display for the computing system. One example application employing the primary display mode is an application for managing and viewing digital photographs. In such an application, the touchpad (or a portion of the touchpad) could be used for display of digital images, for example to provide a slideshow of a selected collection of photographs.

It should now be appreciated that the touchpads of the present description may be operated in various modes, including a basic input mode providing cursor control, a visual effects output mode, and a primary display output mode. Moreover, these modes may be employed simultaneously on the touchpad. When two or more modes are employed at the same time, one mode may be employed in connection with a first region or portion of the touchpad, with another mode being employed on a second region or portion of the touchpad. On the other hand, in some cases it will be desirable to employ more than one mode on the same region of the touchpad at the same time. Indeed, as discussed above, many of the examples discussed herein involve a single region of the touchpad providing both basic input cursor control and visual effects output based on the applied touch inputs.

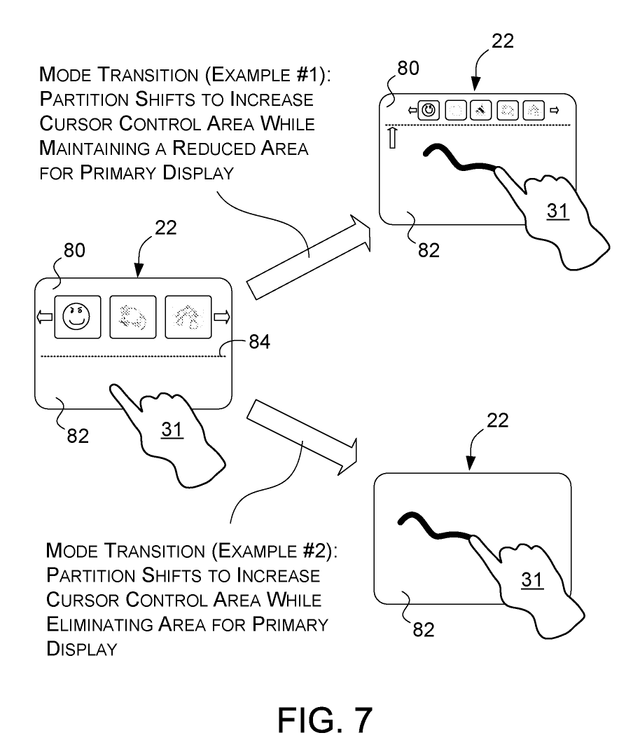

Referring now to FIG. 7, the figure will be used to further describe touchpad operating modes and mode-switching methods. As shown in FIG. 7, touchpad 22 is shown as being partitioned into two separate portions. Upper portion 80 is driven by touchpad output module 42 (FIG. 1) in a primary display mode to provide an additional primary display that supplements the display screen area provided by primary display 32. In the depicted example, the additional primary display is shown as providing a slideshow of digital images. Meanwhile, lower portion 82 is being driven by touchpad input module 34 to provide cursor control for the computing system, and may also be provided with visual effects output from touchpad output module 42, to provide the aforementioned visual effects in response to touch inputs. In the depicted example, interface subsystem 28 has partitioned the input and output regions so that that there is a divider 84 between the two sections, as indicated by the horizontal dashed line in the figure. The divider may or may not be visible to the user.

In some cases where the touchpad is used for primary display, it will be desirable to perform a mode transition to enable more of the touchpad to be used for input functionality. One way of triggering the transition is in response to a predetermined touch input, referred to herein as a mode-switching touch input. Typically, touchpad input module 34 is operative to sense the mode-switching touch input, and then the interface subsystem in response causes the touchpad operation to transition or modulate the touchpad mode(s).

The upper right portion of the figure shows a first exemplary mode transition. In this transition, the section devoted to the additional primary display functionality (portion 80) has decreased in size, and the input portion (portion 82) has increased in size to allow a greater portion of the touchpad operative surface to receive cursor control touch inputs. In the example, visual effects output has also been enabled (e.g., a finger paint persistence trail) on the input portion of the touchpad, although it should be appreciated that a basic input mode could also be used without visual effects output.

The lower right portion shows an alternate exemplary transition, in which the portion allotted for the additional primary display has been reduced in size to zero (so as to eliminate the additional primary display). In other words, in response to the triggering touch input, the mode transition causes the entire touchpad to switch over to receiving cursor control input, and the additional primary display functionality is at least temporarily turned off. In both mode transition examples, interface subsystem 28 may detect when the added input area is no longer needed, and then appropriately reverse the mode transition back to the initial state shown in FIG. 7. For example, when the user withdraws their finger from the touchpad, the withdrawal may precipitate the return to the initial partition shown in the figure.

The particular touch input that is interpreted as the mode-switching touch input which triggers the mode transition may vary. In one example, any touch input applied to the input section (portion 82) would be the mode-switching touch input which would cause the expansion of the input area shown in the transition examples #1 and #2. Another example would be to cause a transition in response to any touch input applied to any location on the touchpad. As a still further example, the interface subsystem would dynamically sense the “need” for an expanded input region, for example by only causing the input expansion when a touch input was received in an area close to or approaching divider 84. Touch inputs that remained squarely confined to the original dedicated input area would not trigger the transition.

A further variation on the example of FIG. 7 would be to start with the entire area partitioned for additional primary display functionality. In other words, the partition dedicated to input functionality would have a size of zero. Upon receipt of the triggering input, transitions could be made as in the transition examples #1 and #2 of FIG. 7, such that some or all of the touchpad surface would be made available to receive cursor control touch inputs. In any case, the state transitions typically will involve an expansion of a region of the touchpad operative surface that is dedicated to receiving cursor control touch inputs.

Referring again to various components of FIG. 1, it should be understood that logic subsystem 24 may include one or more physical devices configured to execute one or more instructions. For example, the logic subsystem may be configured to execute one or more instructions that are part of one or more programs, routines, objects, components, data structures, or other logical constructs. Such instructions may be implemented to perform a task, implement a data type, transform the state of one or more devices, or otherwise arrive at a desired result. The logic subsystem may include one or more processors that are configured to execute software instructions, such as to carry out functionality of the interface subsystem 28. Additionally or alternatively, the logic subsystem may include one or more hardware or firmware logic machines configured to execute hardware or firmware instructions. The logic subsystem may optionally include individual components that are distributed throughout two or more devices, which may be remotely located in some embodiments.

The data-holding subsystem 26 may include one or more physical devices configured to hold data and/or instructions executable by the logic subsystem to implement the herein described methods and processes. When such methods and processes are implemented, the state of the data-holding subsystem may be transformed (e.g., to hold different data). The data-holding subsystem may include removable media and/or built-in devices. The data-holding subsystem may include optical memory devices, semiconductor memory devices, and/or magnetic memory devices, among others. The data-holding subsystem may include devices with one or more of the following characteristics: volatile, nonvolatile, dynamic, static, read/write, read-only, random access, sequential access, location addressable, file addressable, and content addressable. In some embodiments, the logic subsystem and data-holding subsystem may be integrated into one or more common devices, such as an application specific integrated circuit or a system on a chip.

When included, a display subsystem such as subsystem 30 may be used to present a visual representation of data held by a data-holding subsystem. As the herein described methods and processes change the data held by the data-holding subsystem, and thus transform the state of the data-holding subsystem, the state of the display subsystem may likewise be transformed to visually represent changes in the underlying data. The display subsystem may include one or more display devices utilizing virtually any type of technology. Such display devices may be combined with a logic subsystem and/or a data-holding subsystem in a shared enclosure, or such display devices may be peripheral display devices.

It is to be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A computing system, comprising:
a primary display;
a touchpad having an operative surface that is distinct from a display surface of the primary display; and
an interface subsystem, including:
a touchpad input module responsive to touch inputs applied to the operative surface of the touchpad to provide cursor control over data represented on the primary display; and
a touchpad output module operative to drive the touchpad to display visual effects on the operative surface of the touchpad based on the touch inputs.

2. The system of claim 1, where the touchpad output module is operative to drive the touchpad to display a visual persistence effect on the operative surface of the touchpad in response to a touch input applied to the operative surface of the touchpad.

3. The system of claim 2, where the visual persistence effect is a visible trail on the operative surface of the touchpad, the visible trail being positioned in a wake region of a dynamic touch input applied to the operative surface of the touchpad.

4. The system of claim 3, where the visible trail is transitory and fades from the operative surface over time.

5. The system of claim 1, where the touchpad output module is operative to drive the touchpad to display a contact visual effect on the operative surface of the touchpad in response to a touch input applied to the operative surface of the touchpad, where the contact visual effect is generated so as to be visible on a region of the operative surface which is proximally adjacent a location of the operative surface where the touch input is applied.

6. The system of claim 5, where the contact visual effect is a visual simulation of a mechanical deflection of the operative surface of the touchpad.

7. The system of claim 1, where the touchpad output module is further configured to drive the touchpad in a primary display mode so that at least a portion of the operative surface of the touchpad provides an additional primary display of the computing system, instead of receiving touch inputs for cursor control.

8. The system of claim 7, where when the touchpad output module is driving the touchpad in the primary display mode, the interface subsystem is responsive to a mode-switching touch input to cause a decrease in the portion of the operative surface of the touchpad that provides the additional primary display, and an increase in a portion of the operative surface of the touchpad that is responsive to touch inputs to provide cursor control over the computing system.

9. A computing system, comprising:
a primary display;
a touchpad having an operative surface that is distinct from a display surface of the primary display; and
an interface subsystem, including:
a touchpad input module responsive to touch inputs applied to the operative surface of the touchpad to provide cursor control over data represented on the primary display; and
a touchpad output module operative to drive the touchpad selectively in a visual effects output mode, in which the touchpad output module drives the touchpad to display visual effects on the operative surface of the touchpad based on the touch inputs, and in a primary display mode, in which the touchpad output module drives the touchpad so that at least a portion of the operative surface provides an additional primary display of the computing system, instead of receiving touch inputs for cursor control.

10. The system of claim 9, where the interface subsystem is configured to partition the operative surface of the touchpad into a first portion dedicated to receiving the touch inputs to provide the cursor control and a second portion dedicated to providing the additional primary display.

11. The system of claim 10, where the interface subsystem is responsive to a mode-switching touch input applied to the operative surface of the touchpad such that, upon sensing the mode-switching touch input, the first portion is increased in size and the second portion is decreased in size.

12. The system of claim 11, where the interface subsystem is responsive to the mode-switching touch input such that, upon sensing the mode-switching touch input, the first portion is increased in size and the second portion is decreased in size to zero so as to at least temporarily disable the additional primary display.

13. The system of claim 10, where the first portion is operated in the visual effects output mode to provide visual effects on the first portion based on the touch inputs.

14. The system of claim 13, where the visual effects provided on the first portion include a visual persistence effect on the first portion in response to a touch input applied to the first portion.

15. The system of claim 14, where the visual persistence effect is a visible trail on the first portion, the visible trail being positioned in a wake region of a dynamic touch input applied to the first portion.

16. The system of claim 13, where the visual effects provided on the first portion include a contact effect on the first portion in response to a touch input applied to the first portion.

17. A computing system, comprising:
a primary display;
a touchpad having an operative surface that is distinct from a display surface of the primary display; and
an interface subsystem, including:
a touchpad input module responsive to touch inputs applied to the operative surface of the touchpad to provide cursor control over data represented on the primary display; and
a touchpad output module operative to drive the touchpad in a primary display mode in which the touchpad output module drives the touchpad so that at least a portion of the operative surface provides, instead of receiving touch inputs for cursor control, an additional primary display of the computing system,
where, when the touchpad is being driven in the primary display mode, the interface subsystem is responsive to a mode-switching touch input applied to the touchpad to cause expansion of a region of the operative surface of the touchpad that is allocated to receive cursor control touch inputs.

18. The system of claim 17, where the interface subsystem is configured to operate the touchpad in a first state, in which a first portion of the operative surface of the touchpad provides the additional primary display and a second portion is dedicated to receiving the touch inputs to provide the cursor control, and in a second state, in which the first portion and the second portion retain function but the first portion is relatively smaller than in the first state and the second portion is relatively larger than in the first state, where the interface subsystem is configured to cause transition from the first state to the second state in response to the mode-switching touch input.

19. The system of claim 17, where the interface subsystem is configured to operate the touchpad in a first state, in which substantially all of the operative surface of the touchpad provides the additional primary display, and a second state, in which a first portion of the operative surface of the touchpad provides the additional primary display and a second portion is dedicated to receiving the touch inputs to provide the cursor control, where the interface subsystem is configured to cause transition from the first state to the second state in response to the mode-switching touch input.

20. The system of claim 17, where the touchpad output module is configured to drive the touchpad in a visual effects output mode, in which the touchpad output module drives the touchpad to display visual effects on the operative surface of the touchpad based on the touch inputs applied to the operative surface to provide the cursor control.
